(19) United States
(12) Patent Application Publication
(10) Pub. No.: US 2008/0088802 A1
(43) Pub. Date: Apr. 17, 2008

(54) ELECTRONIC DEVICE

(75) Inventor: Fu Shiung Shih, Taichung County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/830,714

(22) Filed: Jul. 30, 2007

(30) Foreign Application Priority Data
Oct. 16, 2006 (TW) TW95138035

(51) Int. Cl. G03B 21/16

(52) U.S. Cl. 353/58; 353/52

(57) ABSTRACT

An electronic device includes a housing, a lamp having a voltage rating, a ballast electrically connected to the lamp, a main board having a predetermined voltage and electrically connected to the ballast, a first fan electrically connected to the main board, and a second fan electrically connected to the main board. The lamp, the ballast, the main board, the first fan and the second fan are disposed in the housing, and the first fan is nearer the ballast than the second fan. When the voltage rating of the lamp is greater than the predetermined voltage of the main board, the main board actuates the first and second fans to dissipate heat from the lamp and other elements in the housing. When the voltage rating of the lamp is less than the predetermined voltage of the main board, the ballast actuates only the first fan to dissipate heat from the lamp.

### BACKGROUND OF THE INVENTION

1. Field of the Invention

The invention relates to an electronic device, and more particularly to an electronic device capable of controlling the speed of a fan based on a detected environmental or local temperature of a system to prevent abnormal ballast shutdown.

2. Description of the Related Art

Conventional projectors typically maintain a normal operating temperature by controlling a fan based on a detected environmental temperature, or temperature detected at a particular position in the projector. A single voltage lamp is typically installed in the projector during the manufacturing process. Currently, there are two major types of single voltage lamps, high and low voltage lamps. When a projector comprises a high-voltage lamp, a ballast of the projector correspondingly generates a low temperature. When a projector comprises a low-voltage lamp, the ballast of the projector generates a correspondingly high temperature, thus, abnormal shutdown may occur. Although increasing fan speed can dissipate the heat generated by the high-temperature ballast and low-voltage lamp, increased noise results.

### BRIEF SUMMARY OF THE INVENTION

An electronic device for eliminating abnormal shutdown due to high-temperature ballast is provided. The electronic device of the invention comprises a light generating unit with a rated voltage, a first heat dissipation device, a first circuit unit of predetermined voltage electrically connected to the first heat dissipation device, and a second circuit unit electrically connected to the first circuit unit and the light generating unit. When the voltage rating of the light generating unit is greater than the predetermined voltage of the first circuit unit, the first circuit unit actuates the first heat dissipation device to dissipate heat from the light generating unit. When the voltage rating of the light generating unit is less than the predetermined voltage of the first circuit unit, the second circuit unit actuates the first heat dissipation device to dissipate heat from the light generating unit.

The electronic device further comprises a first sensor electrically connected to the first circuit unit. When the voltage rating of the light generating unit is greater than the predetermined voltage of the first circuit unit, the first circuit unit utilizes the first sensor to actuate the first heat dissipation device to dissipate heat from the light generating unit. The first sensor is disposed on the first circuit unit.

The electronic device further comprises a first sensor electrically connected to the first circuit unit for detecting and utilizing an environmental temperature to control the first heat dissipation device to dissipate heat if the environmental temperature is greater than a predetermined value.

The electronic device further comprises a first sensor electrically connected to the first circuit unit for detecting and utilizing a first local temperature of the first circuit unit to control the first heat dissipation device to dissipate heat if the first local temperature is greater than a first normal value thereof.

The electronic device further comprises a second sensor electrically connected to the second circuit unit. The second circuit unit utilizes the second sensor to actuate the first heat dissipation device to dissipate heat from the light generating unit when the voltage rating of the light generating unit is less than the predetermined voltage of the first circuit unit.

The electronic device further comprises a second sensor electrically connected to the second circuit unit for detecting and utilizing an environmental temperature to control the first heat dissipation device to dissipate heat if the environmental temperature is greater than a predetermined value.

The electronic device further comprises a second sensor electrically connected to the second circuit unit for detecting and utilizing a second local temperature of the second circuit unit to control the first heat dissipation device to dissipate heat if the second local temperature is greater than a second normal value thereof. The second sensor is disposed on the second circuit unit.

The electronic device further comprises a second heat dissipation device electrically connected to the first circuit unit, wherein the first heat dissipation device is nearer the second circuit unit than the second heat dissipation device.

The electronic device further comprises a lens assembly disposed adjacent to the light generating unit and used to project light beams from the light generating unit.

The electronic device can be a projector. The light generating unit comprises a lamp. The first circuit unit can be a main board. The second circuit unit can be a ballast. The first heat dissipation device can be a fan. The second heat dissipation device can be a fan.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an electronic device (E) of the invention; and

FIG. 2 is a schematic view of an application of the electronic device (E) of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

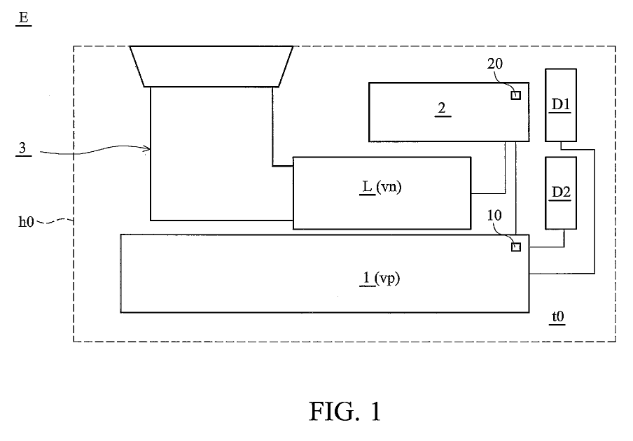

In FIG. 1, an electronic device E of the invention comprises a housing h0, a light generating unit L with a voltage rating vn, a first heat dissipation device D1, a second heat dissipation device D2, a first circuit unit 1 electrically connected to the first heat dissipation device D1 and comprising a predetermined voltage vp, a second circuit unit 2 electrically connected to the first circuit unit 1 and the light generating unit L, a lens assembly 3 disposed adjacent to the light generating unit L, a first sensor 10, and a second sensor 20. The light generating unit L, the first circuit unit 1, the second circuit unit 2 and the lens assembly 3 are disposed in the housing h0. The first heat dissipation device D1 is nearer the second circuit unit 2 than the second heat dissipation device D2.

In this embodiment, the electronic device E is a projector, the light generating unit L is a lamp, the first circuit unit 1 is a main board, the second circuit unit 2 is a ballast, the first heat dissipation device D1 is a first fan, and the second heat dissipation device D2 is a second fan.

The main board 1 is electrically connected to the ballast 2, the first fan D1 and the second fan D2. The lamp L disposed adjacent to the lens assembly 3 is electrically connected to the ballast 2. The ballast 2 actuates the lamp L to generate a plurality of light beams, and the lens assembly 3 projects the light beams to a predetermined region. The first and second fans D1 and D2 dissipate heat from the housing h0.

The first sensor 10, electrically connected to the main board 1, detects an environmental temperature t0, e.g. 25° C., and utilizes the environmental temperature t0 to control the first fan D1 to dissipate heat if the environmental temperature t0 is greater than a predetermined value. The second sensor 20 electrically connected to the ballast 2 detects an environmental temperature t0, and utilize the environmental temperature t0 to control the first fan D1 to dissipate heat if the environmental temperature t0 is greater than the predetermined value.

When the voltage rating vn of the lamp L is greater than the predetermined voltage vp of the main board 1, the main board 1 utilizes the first sensor 10 to actuate the first and second fans D1 and D2 to dissipate heat from the lamp L. When the voltage rating vn of the lamp L is less than the predetermined voltage vp of the main board 1, the ballast 2 utilizes the second sensor 20 only to actuate the first fan D1 to dissipate heat from the lamp L. Because the first fan D1 is nearer the ballast 2 than second fan D2, the heat dissipation effect of the first fan D1 on the ballast 2 is better than the second fan D2 when the voltage rating vn of the lamp L is less than the predetermined voltage vp of the main board 1. Thus, heat from the ballast 2 is quickly dissipated and abnormal shutdown of the ballast 2 is prevented.

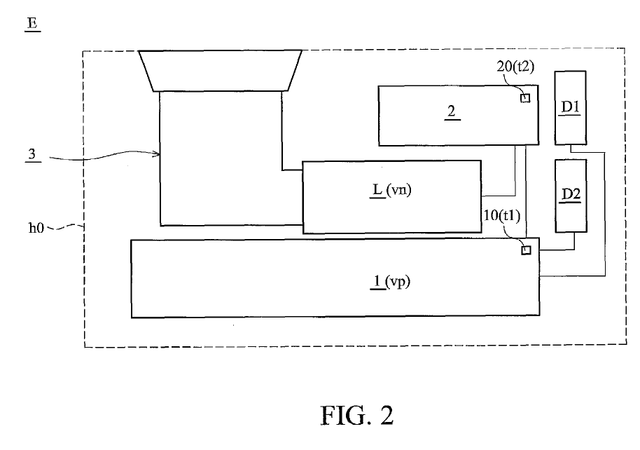

FIG. 2 shows another application of the electronic device E of the invention. This application differs from that in FIG. 1 in that the first sensor 10 detects a first local temperature t1 of the main board 1 and utilizes the first local temperature t1 to control the first and second fans D1 and D2, and the second sensor 20 detects a second local temperature t2 of the ballast 2 and utilizes the second local temperature t2 to control the first fan D1 to dissipate heat if the second local temperature t2 is greater than a second normal value thereof. The first local temperature t1 is directly detected from the main board 1, and the second local temperature t2 is directly detected from the ballast 2.

When the voltage rating vn of the lamp L is greater than the predetermined voltage vp of the main board 1, the main board 1 utilizes the first sensor 10 to actuate the first and second fans D1 and D2 to dissipate heat from the lamp L. When the voltage rating vn of the lamp L is less than the predetermined voltage vp of the main board 1, the ballast 2 utilizes the second sensor 20 to actuate only the first fan D1 to dissipate heat from the lamp L. Thus, heat from the ballast 2 is quickly dissipated and abnormal shutdown of the ballast 2 is prevented.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a light generating unit with a voltage rating;
a first heat dissipation device;
a first circuit unit electrically connected to the first heat dissipation device, comprising a predetermined voltage; and
a second circuit unit electrically connected to the first circuit unit and the light generating unit, wherein the first circuit unit actuates the first heat dissipation device to dissipate heat from the light generating unit when the voltage rating of the light generating unit is greater than the predetermined voltage of the first circuit unit, and the second circuit unit actuates the first heat dissipation device to dissipate heat from the light generating unit when the voltage rating of the light generating unit is less than the predetermined voltage of the first circuit unit.

2. The electronic device as claimed in claim 1, wherein the light generating unit comprises a lamp.

3. The electronic device as claimed in claim 1 further comprising a first sensor electrically connected to the first circuit unit, wherein the first circuit unit utilizes the first sensor to actuate the first heat dissipation device to dissipate heat from the light generating unit when the voltage rating of the light generating unit is greater than the predetermined voltage of the first circuit unit.

4. The electronic device as claimed in claim 3, wherein the first sensor is disposed on the first circuit unit.

5. The electronic device as claimed in claim 1 further comprising a first sensor electrically connected to the first circuit unit for detecting an environmental temperature, and utilize the environmental temperature to control the first heat dissipation device.

6. The electronic device as claimed in claim 1 further comprising a first sensor electrically connected to the first circuit unit for detecting a first local temperature of the first circuit unit, and utilize the first local temperature to control the first heat dissipation device.

7. The electronic device as claimed in claim 1 further comprising a second sensor electrically connected to the second circuit unit, wherein the second circuit unit utilizes the second sensor to actuate the first heat dissipation device to dissipate heat from the light generating unit when the voltage rating of the light generating unit is less than the predetermined voltage of the first circuit unit.

8. The electronic device as claimed in claim 1 further comprising a second sensor electrically connected to the second circuit unit for detecting an environmental temperature, and utilize the environmental temperature to control the first heat dissipation device.

9. The electronic device as claimed in claim 1 further comprising a second sensor electrically connected to the second circuit unit for detecting a second local temperature of the second circuit unit, and utilize the second local temperature to control the first heat dissipation device.

10. The electronic device as claimed in claim 9, wherein the second sensor is disposed on the second circuit unit.

11. The electronic device as claimed in claim 1 further comprising a second heat dissipation device electrically connected to the first circuit unit, wherein the first heat dissipation device is nearer the second circuit unit than the second heat dissipation device.

12. The electronic device as claimed in claim 1, wherein the first circuit unit comprises a main board.

13. The electronic device as claimed in claim 1, wherein the second circuit unit comprises a ballast.

14. The electronic device as claimed in claim 1, wherein the electronic device comprises a projector.

15. The electronic device as claimed in claim 1, wherein the first heat dissipation device comprises a fan.

16. The electronic device as claimed in claim 1, wherein the second heat dissipation device comprises a fan.

17. The electronic device as claimed in claim 1 further comprising a lens assembly disposed adjacent to the light generating unit.
